(19) United States
(12) Patent Application Publication
(10) Pub. No.: US 2018/0115952 A1
(43) Pub. Date: Apr. 26, 2018

(54) PHYSICAL LAYER DESIGN FOR WAKEUP RADIO

(71) Applicant: QUALCOMM Incorporated, San Diego, CA (US)

(72) Inventors: Stephen Jay Shellhammer, Ramona, CA (US); Bin Tian, San Diego, CA (US)

(21) Appl. No.: 15/788,471

(22) Filed: Oct. 19, 2017

Related U.S. Application Data
(60) Provisional application No. 62/411,440, filed on Oct. 21, 2016.

(51) Int. Cl. H04W 52/02; H04L 12/26; H04W 64/00

(52) U.S. Cl. CPC H04W 52/0229; H04L 43/0847; H04W 84/12; H04W 52/0216; H04W 52/0238; H04W 64/003

(57) ABSTRACT

Techniques are described in this disclosure of a physical layer design for wakeup messages having multiple types of wakeup messages. Such designs may include a standard wakeup message having a first bit duration and a low-sensitivity wakeup message having a second bit duration. During operation, the access point (AP) may select which type of wakeup message to use when communicating with a wireless device or a group of wireless devices. Wakeup intervals during a low-power mode of the wireless device may be adjusted based at least in part on which type of wakeup message is being used. Parameter values for the wakeup messages may be determined based at least in part on proximity of the wireless device relative to the AP.

### CROSS REFERENCES

The present Application for Patent claims priority to U.S. Provisional Patent Application No. 62/411,440 by Shellhammer, et al., entitled “Physical Layer Design For Wakeup Receiver,” filed Oct. 21, 2016, assigned to the assignee hereof, and expressly incorporated by reference herein.

### BACKGROUND

The present disclosure relates generally to wireless communication, and more specifically to physical layer design for wakeup radio.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

A wireless device may have a limited amount of battery power. During a sleep mode, a wireless device may periodically activate a radio, which may include a wakeup receiver, to listen for and decode a wakeup message from an AP. The wakeup message may indicate whether communications are waiting at the AP to be transmitted to the wireless device. In some cases, the wireless device may not decode the wakeup message successfully.

### SUMMARY

The described techniques relate to improved methods, systems, devices, or apparatuses that support physical layer design for a wakeup radio. Generally, the described techniques provide for a physical layer design for wakeup messages having multiple types or formats of wakeup messages. Such designs may include a standard wakeup message having a first bit duration and a low-sensitivity wakeup message having a second bit duration (e.g., where the bit duration may be an duration, interval, length, bit length, etc.). During operation, an access point (AP) may select which type of wakeup message to use when communicating with a wireless device or a group of wireless devices based at least in part on a proximity of the wireless device to the AP. Wakeup intervals during a low-power mode of the wireless device may be adjusted based at least in part on which type of wakeup message is being used. The wireless device may decode the wakeup message to obtain a device specific message. A parameter value for the wakeup message may be selected based at least in part on a proximity of the wireless device relative to the AP. A first parameter value for the wakeup message may correspond to a wakeup message being a standard wakeup message, while a second parameter value for the wakeup message may be associated with the wakeup message being a low-sensitivity wakeup message.

An apparatus for wireless communication is described. The apparatus may include a processor, memory in electronic communication with the processor, and instructions stored in the memory. The instructions may be operable to cause the apparatus to identify a proximity of the wireless device to the access point, select a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message, transmit the wakeup message to a first radio of the wireless device, the wakeup message generated based at least in part on the selected parameter value, and exchange data with a second radio of the wireless device based at least in part on the transmitted wakeup message.

A method of wireless communication is described. The method may include identifying a proximity of the wireless device to the access point, selecting a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message, transmitting the wakeup message to a first radio of the wireless device, the wakeup message generated based at least in part on the selected parameter value, and exchanging data with a second radio of the wireless device based at least in part on the transmitted wakeup message.

An apparatus for wireless communication is described. The apparatus may include means for identifying a proximity of the wireless device to the access point, means for selecting a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message, means for transmitting the wakeup message to a first radio of the wireless device, the wakeup message generated based at least in part on the selected parameter value, and means for exchanging data with a second radio of the wireless device based at least in part on the transmitted wakeup message.

A non-transitory computer readable medium for wireless communication is described. The non-transitory computer-readable medium may include instructions operable to cause a processor to identify a proximity of the wireless device to the access point, select a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message, transmit the wakeup message to a first radio of the wireless device, the wakeup message generated based at least in part on the selected parameter value, and exchange data with a second radio of the wireless device based at least in part on the transmitted wakeup message.

In some examples of the method, apparatuses, and non-transitory computer-readable medium described above, identifying the proximity of the wireless device to the access point includes: determining a packet error rate associated with messages transmitted by the access point.

In some examples of the method, apparatuses, and non-transitory computer-readable medium described above, identifying the proximity of the wireless device to the access point further includes: comparing the determined packet error rate to a predetermined packet error rate threshold.

In some examples of the method, apparatuses, and non-transitory computer-readable medium described above, identifying the proximity of the wireless device to the access point includes: identifying a path loss between the wireless device and the access point. Some examples of the method, apparatus, and non-transitory computer-readable medium described above may further include processes, features, means, or instructions for comparing the path loss to a predetermined path loss threshold.

In some examples of the method, apparatuses, and non-transitory computer-readable medium described above, identifying the proximity of the wireless device to the access point includes: identifying a receive power associated with a signal of the wireless device. Some examples of the method, apparatus, and non-transitory computer-readable medium described above may further include processes, features, means, or instructions for comparing the identified receive power to a predetermined power threshold.

Some examples of the method, apparatuses, and non-transitory computer-readable medium described above further include processes, features, means, or instructions for receiving an indication of the proximity of the wireless device to the access point identified based at least in part on the received indication.

In some examples of the method, apparatuses, and non-transitory computer-readable medium described above, transmitting the wakeup message further includes: selecting a pseudo-random noise (PN) sequence associated with the first size or the second size for a preamble of the wakeup message based at least in part on the selected parameter value.

In some examples of the method, apparatuses, and non-transitory computer-readable medium described above, transmitting the wakeup message further includes: modulating a second portion of the wakeup message to a set of symbols associated with the first size or the second size for the second portion of the wakeup message based at least in part on the selected parameter value.

In some examples of the method, apparatuses, and non-transitory computer-readable medium described above, a first portion of the wakeup message includes a preamble. In some examples of the method, apparatus, and non-transitory computer-readable medium described above, a second portion of the wakeup message includes a signal field and a data field.

In some examples of the method, apparatus, and non-transitory computer-readable medium described above, the preamble includes a PN field.

In some examples of the method, apparatus, and non-transitory computer-readable medium described above, the signal field indicates a data field size for the data field.

Some examples of the method, apparatus, and non-transitory computer-readable medium described above may include processes, features, means, or instructions for receiving an indication that the wireless device has entered a low-power mode.

In some examples of the method, apparatus, and non-transitory computer-readable medium described above, identifying the proximity may be based at least in part on the received indication that the wireless device has entered the low-power mode.

Some examples of the method, apparatus, and non-transitory computer-readable medium described above may further include processes, features, means, or instructions for assigning the wireless device to a first of a plurality of groups of one or more wireless devices based at least in part on the identified proximity of the wireless device to the access point.

In some examples of the method, apparatus, and non-transitory computer-readable medium described above, the selected data parameter value may include a data rate, or a modulation rate, or a coding rate, or a combination thereof.

Some examples of the method, apparatus, and non-transitory computer-readable medium described above may further include processes, features, means, or instructions for comparing the identified proximity of the wireless device to a predetermined proximity threshold, wherein the parameter value may be selected based at least in part on the comparison.

In some examples of the method, apparatus, and non-transitory computer-readable medium described above, the second size may be an integer multiple of the first size.

In some examples of the method, apparatus, and non-transitory computer-readable medium described above, the first radio comprises a wakeup receiver. In some examples of the method, apparatus, and non-transitory computer-readable medium described above, the second radio comprises a wireless local area network (WLAN) transceiver.

In some examples of the method, apparatus, and non-transitory computer-readable medium described above, the apparatus is a wireless communication terminal and further comprises an antenna and transceiver.

### BRIEF DESCRIPTION OF THE DRAWINGS

FIG. 1 illustrates an example of a system for wireless communication that supports physical layer design for wakeup radio in accordance with aspects of the present disclosure.

FIG. 2 illustrates an example of a wireless communication system that supports physical layer design for wakeup radio in accordance with aspects of the present disclosure.

FIG. 3 illustrates an example of a wireless communication system that supports physical layer design for wakeup radio in accordance with aspects of the present disclosure.

FIG. 4 illustrates an example of a wakeup message that supports physical layer design for wakeup radio in accordance with aspects of the present disclosure.

FIG. 5 illustrates an example of a multiple message formats that supports physical layer design for wakeup radio in accordance with aspects of the present disclosure.

FIG. 6 illustrates an example of a process flow that supports physical layer design for wakeup radio in accordance with aspects of the present disclosure.

FIG. 7 illustrates an example of a bit transformation that supports physical layer design for wakeup radio in accordance with aspects of the present disclosure.

FIGS. 8 through 10 show block diagrams of a device that supports physical layer design for wakeup radio in accordance with aspects of the present disclosure.

FIG. 11 illustrates a block diagram of a system including an access point that supports physical layer design for wakeup radio in accordance with aspects of the present disclosure.

FIGS. 12 through 14 show block diagrams of a device that supports physical layer design for wakeup radio in accordance with aspects of the present disclosure.

FIG. 15 illustrates a block diagram of a system including a wireless device that supports physical layer design for wakeup radio in accordance with aspects of the present disclosure.

FIGS. 16 through 17 illustrate methods for physical layer design for wakeup radio in accordance with aspects of the present disclosure.

### DETAILED DESCRIPTION

To conserve power, some wireless devices may include a primary radio for communicating data during an active state and a wakeup radio (e.g., a low-power radio or companion radio) for communicating data during a low-power state. To ensure that the wireless device receives all communications during a low-power state, the wireless device may periodically wakeup its low-power receiver and listen for a wakeup message from an access point (AP) indicating that communications are waiting to be transmitted to the wireless device. As part of the power conservation, communications associated with the low-power radio may be transmitted at a lower data rate than communications associated with the primary radio. Due to a variety of factors (e.g., distance or interference), the wireless device may be unable to decode some wakeup messages transmitted by the AP that would otherwise be decodable by the primary radio if it were active.

Techniques are described in this disclosure of a physical layer design for wakeup messages having multiple types of wakeup messages. Such designs may include a standard wakeup message having a first bit duration and a low-sensitivity wakeup message having a second bit duration. During operation, the access point (AP) may select which type of wakeup message to use when communicating with a wireless device or a group of wireless devices. Wakeup intervals during a low-power mode of the wireless device may be adjusted based at least in part on which type of wakeup message is being used. Parameter values for the wakeup messages may be determined based at least in part on proximity of the wireless device relative to the AP.

Aspects of the disclosure are initially described in the context of a wireless communications system. Aspects of the disclosure are illustrated by and described with reference to wireless communication systems, packet structures, and process flow diagrams. Aspects of the disclosure are further illustrated by and described with reference to apparatus diagrams, system diagrams, and flowcharts that relate to physical layer design for wakeup radio.

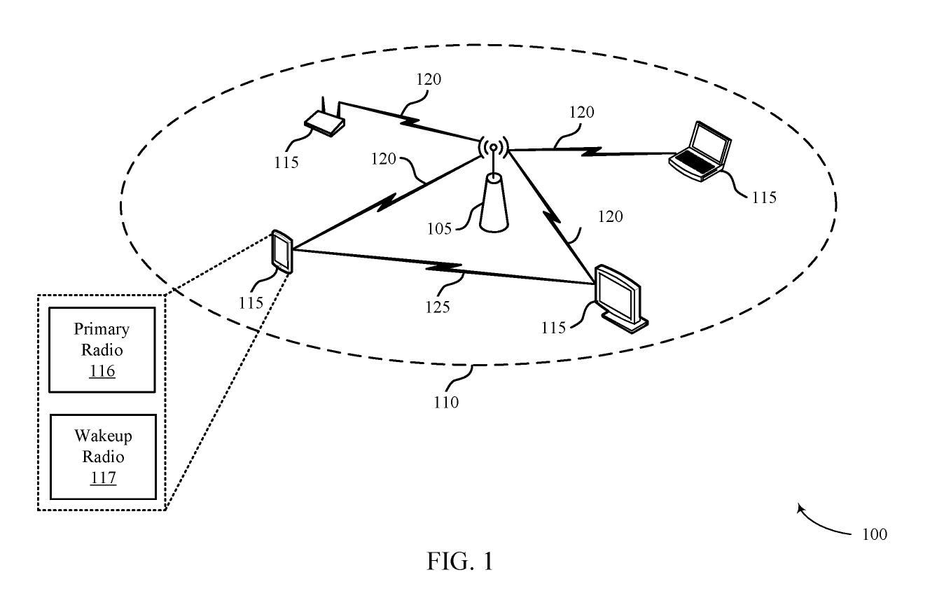

FIG. 1 illustrates a wireless local area network (WLAN) 100 (e.g., a Wi-Fi network) configured in accordance with various aspects of the present disclosure. The WLAN 100 may include an AP 105 and multiple associated wireless devices 115 (sometimes referred to as STAs), which may represent devices such as such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. The AP 105 and the associated wireless devices 115 may represent a basic service set (BSS) or an extended service set (ESS). The various wireless devices 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS. In some instances, a wireless device 115 may use a low-power radio during a low power mode to listen for wakeup messages. However, sometimes distance or interference may reduce the sensitivity of the low-power radio to the point that a wakeup message cannot be decoded. Techniques are described for providing at least two physical layer designs to improve the sensitivity some wireless devices to wakeup messages

A wireless device 115 may be located in the intersection of more than one coverage area 110 and may associate with more than one AP 105. A single AP 105 and an associated set of wireless devices 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two wireless devices 115 may also communicate directly via a direct wireless link 125 regardless of whether both wireless devices 115 are in the same coverage area 110. Examples of direct wireless links 125 may include Wi-Fi Direct connections, Wi-Fi Tunneled Direct Link Setup (TDLS) links, and other group connections. Wireless devices 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within WLAN 100.

In some cases, a wireless device 115 (or an AP 105) may be detectable by a central AP 105, but not by other Wireless devices 115 in the coverage area 110 of the central AP 105. For example, one wireless device 115 may be at one end of the coverage area 110 of the central AP 105 while another wireless device 115 may be at the other end. Thus, both Wireless devices 115 may communicate with the AP 105, but may not receive the transmissions of the other. This may result in colliding transmissions for the two Wireless devices 115 in a contention based environment (e.g., CSMA/CA) because the Wireless devices 115 may not refrain from transmitting on top of each other. A wireless device 115 whose transmissions are not identifiable, but that is within the same coverage area 110 may be known as a hidden node. CSMA/CA may be supplemented by the exchange of a request to send (RTS) packet transmitted by a sending wireless device 115 (or AP 105) and a clear to send (CTS) packet transmitted by the receiving wireless device 115 (or AP 105). This may alert other devices within range of the sender and receiver not to transmit for the bit duration of the primary transmission. Thus, RTS/CTS may help mitigate a hidden node problem. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands. Devices in WLAN 100 may additionally or alternatively communicate over shared licensed spectrum.

In some cases, a wireless device 115 may enter a low-power mode or a sleep mode to conserve power. During the low-power mode, the device may wake periodically to listen for a delivery traffic indication message (DTIM). As part of listening, the wireless device 115 may activate certain radio components used for DTIM reception. In some cases, the wireless device 115 may wake early to account for possible timing asynchronization with the AP 105. If the DTIM is not received at the expected time, the wireless device 115 may wait for a beacon miss timer to expire. If a DTIM (or a standard traffic indication message (TIM)) is received, the wireless device 115 may then wait for the indicated transmission until a content after beacon (CAB) timer expires. If either timer expires, the wireless device 115 may re-enter sleep mode and wait for the next anticipated DTIM/beacon. In some cases, activating and deactivating a radio to receive DTIMs may drain the battery of a power limited device (such as battery powered device that is part of an internet of things (IOT) network).

A wireless device 115 may include a primary radio 116 and a low-power wakeup radio 117 for communication. The primary radio 116 may be used during active modes or for high-data throughput applications. The primary radio 116 may also be referred to as a primary connectivity radio or main radio. The low-power wakeup radio 117 may be used during low-power modes or for low-throughput applications. In some examples, the wakeup radio 117 may include a wakeup receiver and/or a wakeup transmitter. For example, when wireless device 115 or AP 105 may transmit a wakeup message, wireless device 115 may use a wakeup transmitter of its wakeup radio 117. When wireless device 115 may receive a wakeup message, wireless device 115 may use a wakeup receiver of its wakeup radio 117. The wakeup radio 117 may also be referred to as a companion radio, low-power companion radio, low power wakeup radio, etc.

A wakeup radio 117 may utilize a different modulation scheme than the primary radio 116. Modulation is the process of representing a digital signal by modifying the properties of a periodic waveform (e.g., frequency, amplitude and phase). Demodulation takes a modified waveform and generates a digital signal. A modulated waveform may be divided into time units known as symbols. Each symbol may be modulated separately. In a wireless communication system that uses narrow frequency subcarriers to transmit distinct symbols, the modulation is accomplished by varying the phase and amplitude of each symbol. For example, a binary phase-shift keying (BPSK) modulation scheme conveys information by alternating between waveforms that are transmitted with no phase offset or with a 180° offset (i.e., each symbol conveys a single bit of information). In a quadrature amplitude modulation (QAM) scheme, two carrier signals (known as the in-phase component, I, and the quadrature component, Q) may be transmitted with a phase offset of 90° , and each signal may be transmitted with specific amplitude selected from a finite set. The number of amplitude bins determines the number of bits that are conveyed by each symbol. In some examples of the disclosure, a PHY layer for a low power wakeup radio 117 may utilize ON-OFF keying (OOK) modulation and demodulation. OOK may be an example of amplitude modulation, in which information is conveyed by simply transmitting either at a given amplitude (for the ON part of the signal) or at a zero amplitude (for the OFF part of the signal).

According to the present disclosure, an AP 105 may identify a pending communication for a wireless device 115 and may transmit a wakeup message including a device specific identifier to the wakeup radio 117 of the wireless device 115. The wireless device 115 may receive the wakeup message using the wakeup radio 117, decode the message to obtain a device specific identifier e, and activate the primary radio 116. The wakeup message may include a preamble, a signal field, and a data field. In some examples, some of the fields of the wakeup message may be modulated using an OOK mapping (e.g., a ternary OOK mapping). In some cases, the design of the PHY layer for the wakeup radio 117 may be based on operation in an unlicensed frequency spectrum. For example, it may be designed to achieve greater than a threshold bandwidth for a given power below peak of a power spectral density (PSD) representation.

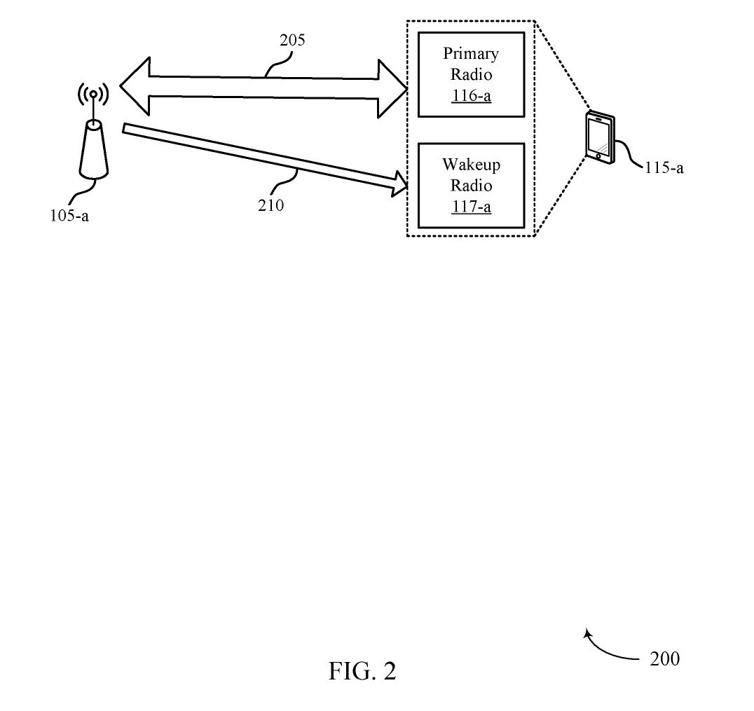

FIG. 2 illustrates an example of a wireless communication system 200 for physical layer design for wakeup radio. Wireless communication system 200 may include a wireless device 115-a and an AP 105-a, which may be an examples of a wireless device 115 and AP 105 described with reference to FIG. 1. The wireless device 115-a may include a primary radio 116-a (which may be similar in some aspects to primary radio 116 of FIG. 1) and a low-power wakeup radio 117-a (which may be similar in some aspects to wakeup radio 117 of FIG. 1). A first communication link 205 may be established between AP 105-a and the primary radio 116-a of the wireless device 115-a. The first communication link 205 may be configured to have a high-throughput of data. A second communication link 210 may be established between the AP 105-a and the low-power wakeup radio 117-a of the wireless device 115-a. The second communication link may be configured to conserve power during communications. The communication links 205, 210 may be examples of wireless links 120 described with reference to FIG. 1.

The wireless devices 115-a may be designed to allow a user to send and receive data to and from various networks and entities. In some circumstances, the wireless device 115-a may be instructed to download a large amount of data. The primary radio 116-a may be configured to provide a relatively high throughput of data to meet the needs of a user of the wireless device 115-a. Radios configured to provide high-data-throughput may require more power than types of radios. In other circumstances, the wireless device 115-a may be inactive. Even during inactive times, data may be sent to the wireless device 115-a (e.g., a text message or an email) and the user may desire to receive that data immediately. During such periods, the maintaining power to the primary radio 116-a (e.g., the high-throughput radio) may needlessly drain power.

During a low-power mode, the AP 105-a may initiate communications with the wireless device 115-a by transmitting a wakeup message including a device specific identifier using the second communication link 210. Once the wireless device 115-a has activated its primary radio 116-a, data may be exchanged via the first communication link 205, which may be capable of a higher throughput of data than the second communication link 210. In one mode, the low power receiver (e.g., the wakeup radio 117-a) may listen for a wake-up message and wake-up a primary radio, which can be placed into its lowest power. In another mode, the low power receiver may be used independently of a primary radio for low power communications (for example, the low power receiver may be used with a battery powered internet of things (IoT) device).

The wireless device 115-a may spend a portion of its time in a low-power state to conserve power. The wakeup radio 117-a may be a low power radio such as a super-regenerative receiver (SRR), so that wireless device 115-a may avoid activating the more power intensive primary radio 116-a to receive periodic DTIM or paging messages. Instead, AP 105-a may transmit a wakeup message including a device specific identifier to the wakeup radio 117-a of wireless device 115-a over the second communication link 210. The PHY layer of the second communication link 210 may be designed specifically for use with a low power radio. For example, it may have a reduced data rate and may be based at least in part on OOK modulation. If the wireless device 115-a receives a wakeup message, it may activate a primary radio 116-a (e.g., a WLAN transceiver based on an 802.11 standard) and communicate with AP 105-a using the primary radio 116 via the first communication link 205.

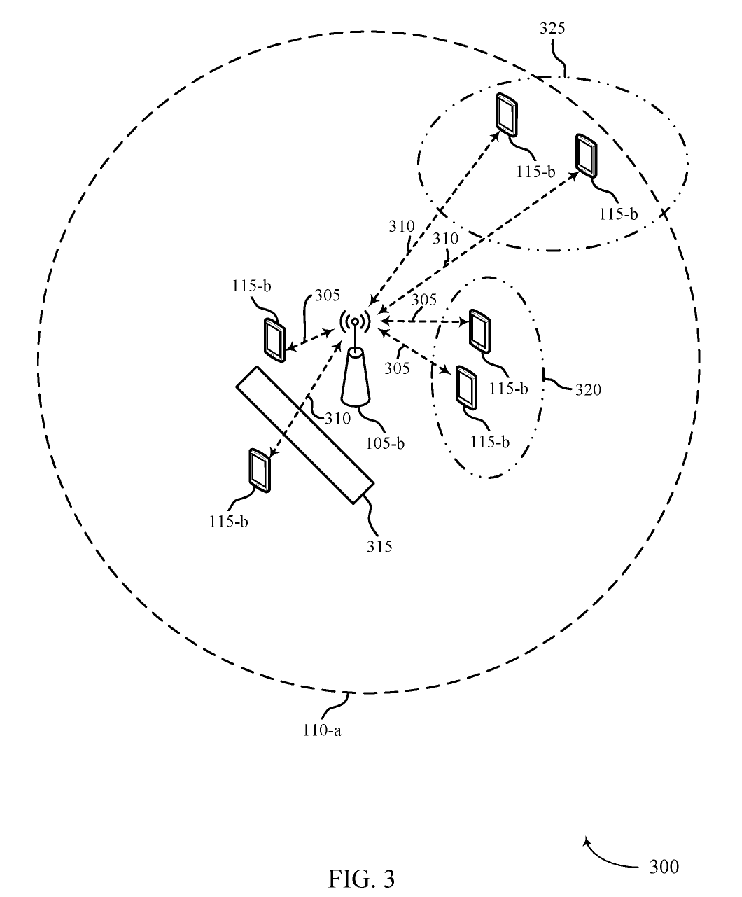

FIG. 3 illustrates an example of a wireless communication system 300 for physical layer design for wakeup radio. The wireless communication system 300 may include one or more APs 105-b and one or more wireless devices 115-b. The wireless communications system may be an example of the WLAN 100 described with reference to FIG. 1. The APs 105-b may be examples of the APs 105 described with reference to FIGS. 1 and 2. The wireless devices 115-b may be examples of the wireless devices 115 described with reference to FIGS. 1 and 2.

In a wireless communication system 300, a low-power wakeup radio 117 may be configured to meet similar design specifications as the primary radio 116. For example, the low-power wakeup radio 117 should be able to detect messages at the same range as the primary radio 116. If the low-power wakeup radio 117 had a shorter range or longer range than the primary radio 116, scenarios may exist that cause a wireless device 115-b to not receive data during a low-power mode. A wakeup radio 117 may have a range similar to the range of a primary radio 116 with which it is paired. If not, a wakeup message from the AP 105-b may not be decodable at the wireless device 115-b and therefore the wireless device 115-b may not exit a low-power mode to receive data waiting to transmitted to the wireless device 115-b.

The low-power wakeup radio 117 may also be configured to have different design specifications as the primary radio 116. For example, the low-power wakeup radio 117 may be configured to consume as little power as possible. To achieve a goal of low power consumption, the low-power wakeup radio 117 may transmit and receive data at a lower data rate in order to reach good sensitivity levels.

In some examples, many wireless devices 115-b may be associated with an AP 105-b. A wakeup radio communication link 305, 310 may be established between the AP 105-b and the wireless devices 115-b. The wakeup radio communication links 305, 310 may be examples of the second communication link 210 described with reference to FIG. 2.

Each of these wireless devices 115-b have varying levels of sensitivity relative to signals transmitted by the AP 105-b. Some wireless devices 115-b may have a wakeup radio communication link 305 that is a high-sensitivity communication link with the AP 105-b. For example, these wireless devices 115-b may be positioned relatively close to the AP 105-b. Some wireless devices 115-b may have a wakeup radio communication link 305 that is a low-sensitivity communication link with the AP 105-b. For example, these wireless devices 115-b may have a wakeup radio communication link 310 that is a low-sensitivity communication link because the wireless devices 115-b are a long distance away from the AP 105-b, an interference source 315 may be affect the communication link, other path loss factors, other interference related issues, or combinations thereof. The interference sources 315 may include sources of electromagnetic interference such as transmitters, physical barriers that affect the propagation of the wave, other sources, or combinations thereof.

The wakeup radio communication link 310 that is a low-sensitivity communication link may be determined in a number of different ways. The sensitivity of the wakeup radio communication link 310 may be determined based at least in part on a packet error rate. In some examples, the packet error rate is determined for each communication link individually. In other examples, the packet error rate may be determined for a region or location based at least in part on historical packet error rates. The AP 105-b may store such historical data. The sensitivity of the wakeup radio communication link 310 may be determined based at least in part on the distance or proximity between the AP 105-b and the wireless device 115-b. The distance may be estimated based at least in part on a timing of a signal, a path loss associated with the signal, or a received power of a reference signal. As the distance increases the path loss may also increase. For example, the distance may be determined based at least in part on the difference between a transmission time of a signal and a reception time of the signal. In other examples, the distance may be determined based at least in part on the detected power level of a received reference signal.

To address situations where wakeup radio communication links 310 that are low-sensitivity that are associated with a low-power radio occur, techniques are disclosed regarding PHY layer designs of wakeup messages. In some instances, multiple PHY layer designs are configured to be used with a low-power radio and a wireless device 115-b in a low-power mode. For example, the wireless communication system 300 may include a standard wakeup message having a first bit duration and a low-sensitivity wakeup message having a second bit duration longer than the first bit duration. The low-sensitivity wakeup message may provide additional sensitivity, but may take more time to transmit than the standard wakeup message. In other examples, any number of different configurations of wakeup messages may be implemented.

During operation, the AP 105-b may determine which packet design or structure to use when communicating with a wireless device 115-b, or a group of wireless devices 115-b. For example, the AP 105-b may identify a first group 320 of wireless devices 115-b that exhibit normal sensitivity to wakeup messages. Where the first group 320 may be configured to receive a standard wakeup message during a low-power mode. The AP 105-b may identify a second group 325 of wireless devices 115-b that exhibit a lower sensitivity to wakeup messages than the first group 320. The second group 325 may be configured to receive a low-sensitivity wakeup message during the low-power mode. As is described herein, various parameter values may be associated with the various groups determined by the AP 105-b. In some cases, the AP 105-b may assign a wireless device 115-b to a group based at least in part on an estimated sensitivity associated with wakeup messages.

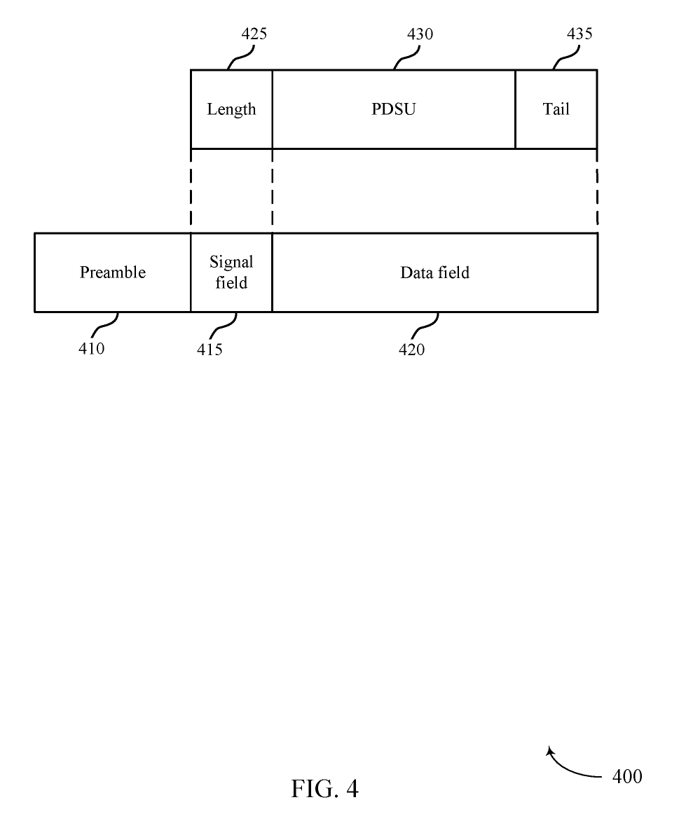

FIG. 4 illustrates an example of a format for a wakeup message 400 for physical layer design for wakeup radio. The format for the wakeup message 400 may be designed for use by a low power receiver such as a SRR and may be used by a wireless device 115 or an AP 105 as described herein with reference to FIGS. 1-3.

The wakeup message 400, which may include a preamble 410, a signal field 415, and a data field 420. The preamble 410 may be used to indicate that a transmission is a wakeup message 400 or to enable synchronization of the receiver. For example, the preamble 410 may include an automatic gain control (AGC) field, which may include twelve symbols. The preamble 410 may also include a PN sequence such as a length 511 maximal length sequence with an additional zero bit appended. Thus, in some examples, the preamble 410 may consist of 524 symbols (e.g., OOK symbols). However, this number is only an example, and other numbers or symbols may be used. In some instances the PN field is a maximal length PN sequence for packet detection and timing recovery.

The signal field 415 may include a length indication 425 of the data field 420. In some cases, a parity bit is appended to the signal field. The parity bit may be used for detection of a bit error in decoding the signal field 415. In some cases, the parity bit may be generated using an exclusive of (XOR) function. In still further cases, the signal field may by encoded using a forward error correction (FEC) encoding such as a repetition-by-three code. Each code bit may also be mapped to a plurality of symbols using a spreading code. For example, each bit may be represented with eight OOK symbols. However, this number is only an example, and other numbers or symbols may be used.

Data field 420 may include the message payload, including, for example, a device identifier for a receiving device, or an indication of data to be exchanged on a primary radio. In some cases, the payload is included in a physical layer service data unit (PSDU) 430. Data field 420 may also include a tail 435, which may include a number of zero bits appended to the end of PSDU 430. In some cases, decoding the signal field 415 with length indication 425 may enable decoding of the data field 420. In some cases, the bits of data field 420 may also be encoded using a spreading code such that each bit is represented using multiple symbols. In some cases the spreading code used for signal field 415 or data field 420 may incorporate a first set of OOK symbols for a “0” bit and a second set of symbols for a “1” bit. The sets of symbols for the different bits may be orthogonal, and may be transmitted such that a baseband representation of each set may have zero direct current (DC) value.

To achieve the zero DC value, or to achieve a desired pulse shape, ternary OOK modulation may be used at the transmitter. That is, half of the “one” OOK symbols are replaced by “negative one” symbols at baseband. Hence, when the baseband signal is modulated by a radio frequency (RF) carrier, there may be little or no impulse in the frequency domain at the carrier frequency. This may be important in the unlicensed frequency band, since the signal bandwidth is measured at, e.g., 6-dB below the peak of the power spectral density (PSD), and in the case of a traditional OOK waveform it may result in a very low bandwidth. In some unlicensed frequency bands (e.g., 900 MHz and 2.4 GHz bands) in order to transmit above a very low power level the signal bandwidth may be greater directed to be greater than 500 kHz. Ternary OOK elimination of the frequency domain impulse at the carrier frequency may enable the signal bandwidth to be greater than a threshold (e.g., 500 kHz) and hence meet a regulatory requirement for a particular dB from peak bandwidth greater than the threshold.

The low power receiver may recover samples from the envelope of the received signal, and may only measure the magnitude of the signal, and cannot detect any phase information. Hence at the super regenerative receiver both “one” and “negative one” OOK symbols may be detected as “one” OOK symbols. As an example, the transmit sequence of ternary OOK symbols {0,1,1,0,0, −1, −1,0} may be received at the low power receiver as {0,1,1,0,0,1,1,0}. In one example, the PHY layer may utilize ternary OOK by converting a maximal length sequence into a sequence of ternary OOK symbol which may be received at the low power receiver as a binary maximal length sequence.

In some examples, spread spectrum spreading and forward error correction coding may be used to lower the data rate, and hence improve the receiver sensitivity, while maintaining a baud rate (e.g., of 500 kHz), in order to meet the regulatory requirement of greater than the threshold bandwidth. Spreading by, for example 8×, may provide not only improved sensitivity but also may provide sufficient symbol transitions at the receiver to dispense with bit scrambling at the transmitter. Thus, in some examples, the overall PHY packet structure may include an AGC field, a ternary maximal length sequence, a coded and spread signal field, and a coded and spread data field.

In some cases, data field 420 may be encoded using a convolutional code, for example, with a coding rate of 1/2. However, this number is only an example, and other coding rates may be used. In some cases, the transmitter may concatenate a LENGTH field from the with data and tail bits, and encode concatenated segment with the rate 1/2 convolutional code. In some cases, messages generated using the message format of FIG. 4 may also be processed by a pulse shaping filter prior to transmission, up-converted to RF, and transmitted based on a center frequency and clock frequency tolerance.

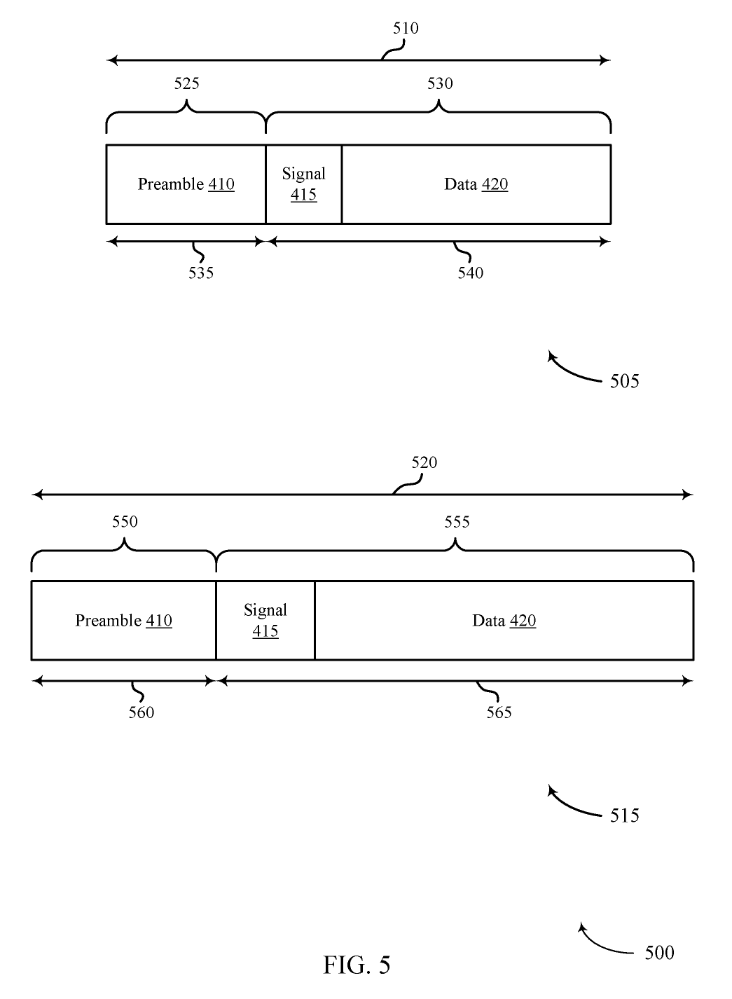

FIG. 5 illustrates an example of a multiple message formats 500 for physical layer design for wakeup radio. The message formats 500 may include a first message 505 having a first bit duration 510 (e.g., a first wakeup message) and a second message 515 having a second bit duration 520 (e.g., a second wakeup message), where the bit duration may be used to mean an interval, length, bit length, duration, etc. While two messages are illustrated, the message formats 500 may include any number of different messages having numerous message lengths (e.g., durations, intervals). The first message 505 and the second 515 may be examples of the wakeup message 400 described with reference to FIG. 4.

Both first message 505 and second message 515 may include a preamble 410, a signal field 415, and a data field 420. The differences between the first message 505 and second message 515 may include the bit duration 510, bit duration 520, the preamble 410, spreading codes used on various portions or fields of the message, or combinations thereof. An AP 105 may determine to transmit one of the first message 505 and second message 515 as a wakeup message to a wireless device 115 based at least in part on the sensitivity of the wireless device 115 to wakeup messages.

The first message 505 may include a first portion 525 and a second portion 530. The first portion 525 may have a bit duration 535 and may include the preamble 410 (e.g., a PN sequence). The second portion 530 may have a bit duration 540 and may include the signal field 415 and the data field 420. In some examples, the first message 505 may be associated with wireless devices 115 that have a normal sensitivity to wakeup messages (e.g., group first 320). Different operations may be applied to the different portions, including first portion 525 and second portion 530 based at least in part on the parameter values. For example, the second portion 530 of the first message 505 may be mapped to a sequence of ternary OOK symbols. Such a mapping may be accomplished based at least in part on a spreading factor. A spreading factor may indicate a size of the ternary OOK mapping to be used in conjunction with the second portion 530. The bit duration 535 of the first portion 525 may be modified by adjusting the sequence length of the preamble 410. For example, the sequence length of the PN field may be modified based at least in part on the parameter values. A ratio of the first message 505 may be defined based at least in part on the bit duration 535 and the bit duration 540.

The second message 515 may include a first portion 550 and a second portion 555. The first portion 550 may have a bit duration 560 and may include the preamble 410 (e.g., a PN sequence). The second portion 555 may have a bit duration 565 and may include the signal field 415 and the data field 420. In some examples, the second message 515 may be associated with wireless devices 115 that have a low sensitivity to wakeup messages (e.g., second group 325). As such, the bit duration 520 may be longer than the bit duration 510. In some examples, the bit duration 520 may be an integer multiple of the bit duration 510. In one example, the bit duration 520 is four times the bit duration 510.

To achieve the longer bit duration 520, different operations may be applied to the message. In some instances, the spreading factor associated with the second portion 555 of the second message 515 may be larger than the spreading factor associated with the second portion 530 of the first message 505. In this manner, the signal field data and the same payload data may have different bit durations, depending on the spreading code (e.g., bit duration 540 and bit duration 565).

In addition, the bit duration of the first portion 550 may be different than the bit duration 535. A ratio of the second message 515 may be defined based at least in part on the bit duration 560 and the bit duration 565. The ratio of the second message 515 may be different than the ratio of the first message 505. The difference may arise because the bit duration of the first portion 550 may not need to be expanded using the same factor as the bit duration of the second portion 555 to achieve higher sensitivity in the wakeup message.

In some instances, the physical layer design may include two different messages: a standard message (e.g., first message 505) and a low-sensitivity message (e.g., second message 515). In some examples, the PN sequence length of the standard message may be 127 bits (or 128 bits if an additional zero OOK systems is added) and the spreading factor used for the signal (SIG) field and data field is eight. In some examples, the PN sequence length of the low-sensitivity message may be 1023 bits (or 1024 bits if an additional OOK symbol is added) and the spreading factor used in SIG field and the data field is sixty-four. In these examples, the low-sensitivity message may be eight times longer than the standard message. The low-sensitivity message may exhibit improved sensitivity when compared to the standard message. In other examples, other values for PN sequence lengths and spreading factors may be used. In some examples, the SIG field and the data field have independently variable lengths. As such, those fields may have different spreading factors applied thereto.

As the length of a wakeup message increases, the amount of time to transmit the wakeup message also increases. Because wireless communication resources are limited, it may be desirable to attempt to limit the duration of a wakeup message. As such, the AP 105 may determine that only a subset set of wireless devices 115 may receive a non-standard wakeup message. In some cases, a wakeup message may be generated that has a duration less than a standard wakeup message. These situations may arise when a wireless device 115 has a high-sensitivity to wakeup messages.

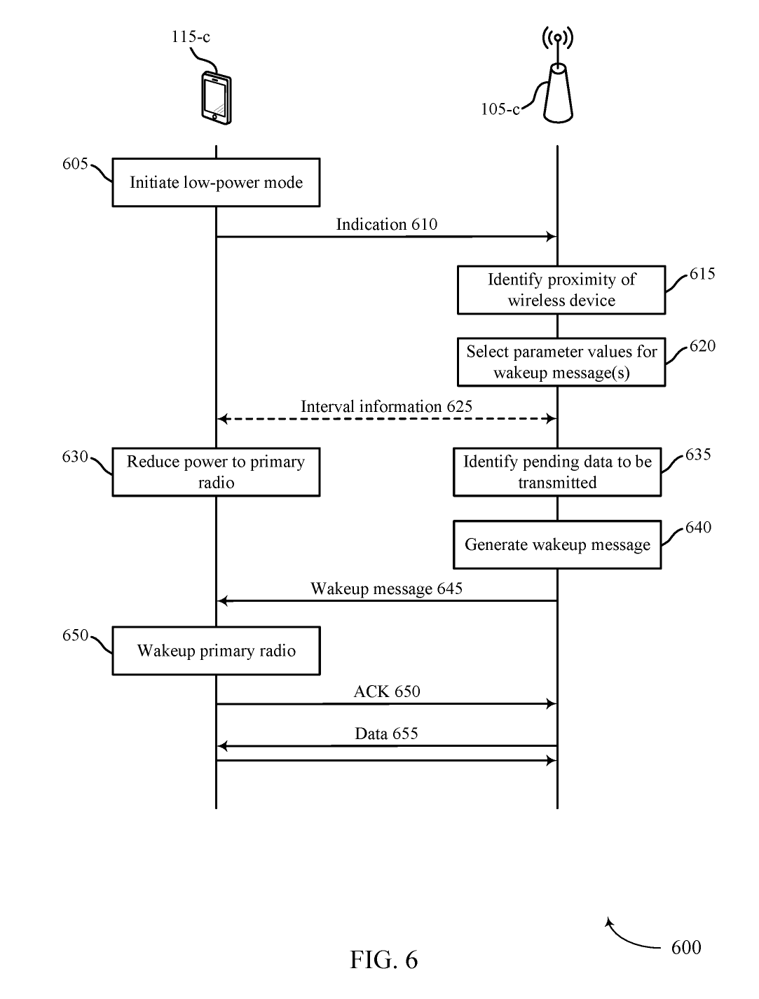

FIG. 6 illustrates an example of a process flow 600 for physical layer design for wakeup radio. The process flow 600 may represent the operation of an AP 105-c and a wireless device 115-c, which may be examples of the devices described herein with reference to FIGS. 1-3. In some cases, the operations described as being performed by AP 105-c or by the wireless device 115-c may be performed by other entities. For example, the operations of the AP 105-c may be performed by a wireless device 115-c in peer mesh network or in device-to-device (D2D) communications.

At block 605, the wireless device 115-c may initiate a low-power mode. A wireless device 115-c may initiate the low-power mode due to a lack of user activity. In an effort to conserve power in a battery-powered device, the wireless device 115-c may enter the low-power state such as a sleep state or a connected standby state. As part of the low-power mode, the wireless device 115-c may turn-off a primary radio (e.g., primary radio 116, 816) to conserve power.

The wireless device 115-c may transmit an indication 610 to the AP 105-c that the wireless device 115-c is entering a low-power state. During a low-power state, the wireless device 115-c may wake up at regular intervals to determine whether pending communications are waiting to be transmitted to the wireless device 115-c by the AP 105-c. The indication 610 may be configured to synchronize the regular wakeup intervals between the wireless device 115-c and the AP 105-c. In some cases, the wakeup intervals are not synchronized, and the AP 105-c may transmit a wakeup message during a period of time that the wireless device 115-c is not listening. In some examples, a low-power radio (e.g., a wakeup receiver of a wakeup radio) is used to listen for DTIMs during these wake up intervals.

At block 615, the AP 105-c may identify a proximity of the wireless device 115-c. In some examples, the identifying may be based at least in part on receiving the indication 610. In some examples, the identifying may be performed at regular intervals independent of the indication 610. As used herein, the term proximity may refer to a sensitivity of a low-power radio (e.g., wakeup radio 117) of the wireless device 115-c to messages transmitted by the AP 105-c. For example, the proximity may be based at least in part on a distance between the wireless device 115-c and the AP 105-c. In some examples, the proximity may be based at least in part on a packet error rate between the wireless device 115-c and the AP 105-c. In some examples, the proximity may be based at least in part on path losses between the wireless device 115-c and the AP 105-c (e.g., associated with a communication link).

To determine the proximity, the AP 105-c may compare various characteristics of signals received from the wireless device 115-c to various thresholds. For example, to determine a proximity, the AP 105-c may compare a reception to a transmission time of a signal received from the wireless device 115-c. In some instances, ranging signals may include information about the transmission time of the ranging signal. A distance between entities may be determined by determining the difference between the transmission time and the reception time. In turn, an estimated sensitivity of the wireless device 115-c may be determined based at least in part on the proximity. The AP 105-c may compare the distance to a predetermined distance threshold. The AP 105-c may select the predetermined distance threshold based at least in part on packet error rates associated with the distance. In some examples, the AP 105-c may determine a proximity based on location data such as global positioning data of the wireless device 115-c. In some examples, the predetermined distance threshold may be based at least in part on characteristics of the secondary receiver, for example of the wakeup radio. For example, specific wakeup radios may exhibit varying levels of sensitivities based at least on their components. A threshold may be based on those individual characteristics of the individual components of an individual wakeup radio.

In other instances, the AP 105-c may determine a proximity based at least in part on signal characteristics of a reference signal received from the wireless device 115-c. For example, a proximity may be based at least in part on a received power level of a reference signal received from the wireless device 115-c. The reference signal may be transmitted at a predetermined power level. The proximity associated with the AP 105-c and the wireless device 115-c may be based at least in part on the received power level of the reference signal satisfying a predetermined power threshold. The AP 105-c may select the predetermined power threshold based at least in part on packet error rates. In some examples, block 615 may be executed by the wireless device 115-c and the roles of the AP 105-c and the wireless device 115-c may be reversed.

At block 620, the AP 105-c may select parameter values for wakeup messages based at least in part on the identified proximity. In some examples, the AP 105-c may select parameter values for wakeup messages based at least in part on a sensitivity of a low-power radio (e.g., wakeup radio 117, 817) of the wireless device 115-c transmitted by the AP 105-c. Parameter values may relate to one or more parameters used to determine the characteristics of a wakeup message. For example, parameters may include a spreading code of a wakeup message, a length of the preamble 410, other parameters, or combinations thereof. Some examples of parameters may include subject matter described with reference to FIGS. 4 and 5. Parameter values may include specific numerical values associated with those parameters. For example, a numerical value of a spreading code may be eight.

Parameter values for wakeup messages to be sent to the wireless device 115-c during it low-power mode may be selected based on the proximity or sensitivity. For example, if the low-power radio of a wireless device 115-c exhibits low sensitivity to wakeup messages, the AP 105-c may select parameters that yield a longer wakeup message (e.g., second message 515).

In some instances, parameter values may be grouped based at least in part on a type of wakeup message they are associated with. For example, a standard wakeup message may include a specific parameter value for the length of the preamble and a specific parameter value for the spreading code. In another example, a low-sensitivity wakeup message may include a specific parameter value for the length of the preamble and a specific parameter value for the spreading code. The parameter values associated with the low-sensitivity wakeup message may be different from the parameters values associated with the standard wakeup message.

To select the parameter values of a wakeup message, the AP 105-c may compare the proximity to a predetermined proximity threshold as those described with reference to block 615. If the proximity satisfies the predetermined proximity threshold, a first set of parameter values for the wakeup message may be selected. Whereas, if the proximity fails to satisfy the predetermined proximity threshold, a second set of parameter values for the wakeup message may be selected. In some examples, there are plurality of predetermined proximity thresholds associated with a plurality of sets of parameter values.

In addition, upon selecting the parameter values, the AP 105-c may determine a wakeup interval based at least in part on the duration of the wakeup message. Wakeup messages with longer durations will take more time to transmit and receive than wakeup messages with shorter durations. As such, the AP 105-c may determine a duration for a listening period and a duration for a sleep period based at least in part on the parameter values of the wakeup message.

The AP 105-c may exchange interval information 625 with the wireless device 115-c based at least in part on the determinations. The interval information 625 may include information related to communicating (e.g., DTIM messages) during the low-power mode of the wireless device 115-c. The interval information 625 may include the parameter values of the wakeup message, the wakeup interval, the duration of the listening period, the duration of the sleep period, other information relevant to entering a low-power mode, or combinations thereof. In some instances, the wireless device 115-c may transmit some interval information to the AP 105-c.

At block 630, the wireless device 115-c may reduce the power to its primary radio. In some examples, such a reduction is based at least in part on receiving the interval information 625 related to the low-power mode. In some examples, reducing the power may include reducing the power to other components to enter a low-power mode.

At block 635, the AP 105-c may identify pending communications or data waiting to be transmitted to the wireless device 115-c. Upon identifying a pending communication, at block 640, the AP 105-c may generate a wakeup message 645 with instructions for the wireless device 115-c to wake up its primary radio (e.g., primary radio 116, 816) to receive the pending communications. In some examples, to identify pending communications, the AP 105-c may check its outgoing data buffer.

The AP 105-c may generate the wakeup message 645 based at least in part on the parameter values determined at block 620. For example, the AP 105-c may generate a longer wakeup message (e.g., second message 515) based at least in part on a distance between the AP 105-c and the wireless device 115-c satisfying a predetermined distance threshold. In some examples, the AP 105-c may generate the wakeup message 645 based at least in part on the parameter values included in the interval information 625. The AP 105-c may transmit the wakeup message 645 during a predetermined listening period of the low-power mode. During the predetermined listening period, the wakeup radio (e.g., wakeup radio 117, 817) may be energized and therefore may receive the wakeup message 645. The wireless device 115-b may activate the wakeup radio until a wakeup message timer expires and then the wireless device 115-b may go back to sleep.

At block 650, upon receiving the wakeup message 645 and decoding the wakeup message 645 successfully, the wireless device 115-c may wakeup its primary radio (e.g., primary radio 116, 816) to listen for the data. In some examples, the wireless device 115-c may transmit an acknowledgement 655 that the wakeup message was received. The wireless device 115-c may continue to power its primary radio until either data 660 is exchanged (e.g., the pending communications) or until a timer expires. While the primary radio is powered, the any data 660 may be exchanged between the wireless device 115-c and the AP 105-c. In some examples, the data 660 is exchanged via the primary radio and not the low-power radio.

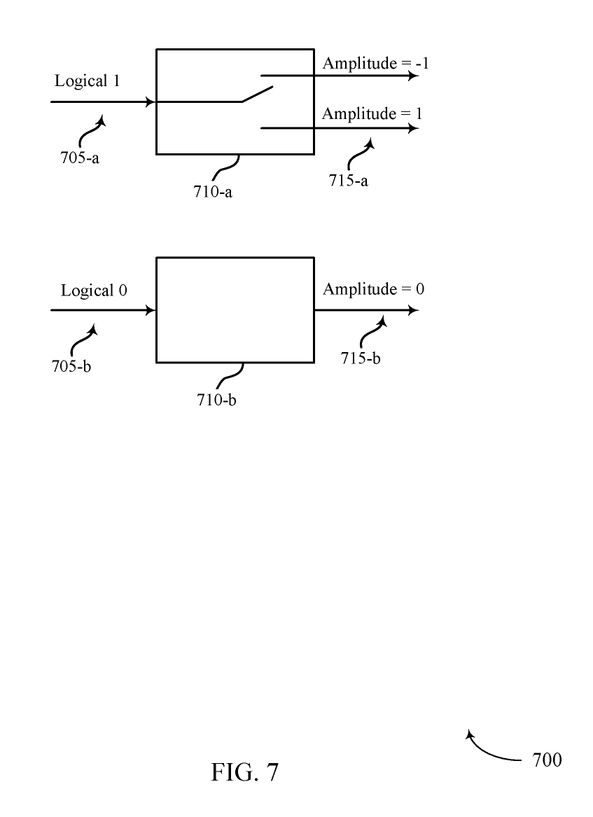

FIG. 7 illustrates an example of a bit transformation 700 for physical layer design for wakeup radio. The bit transformation 700 may include binary OOK inputs 705-a and 705-b, transformations 710-a and 710-b, and ternary OOK outputs 715-a and 715-b.

In some unlicensed bands there may be a minimum bandwidth constraint on the wireless transmission. In some versions of OOK, which may be a digital modulation of the RF signal, in the frequency domain there may be a strong signal at the carrier frequency. This may lead to a narrowband signal when measured at a point where the signal may be 6 dB lower than at the peak value in the frequency domain. So the bandwidth of OOK signal may be narrowband and hence may not meet a minimum bandwidth standard. This may be true even when the modulation rate is increased, since the 6-db bandwidth may be controlled by the strong carrier signal in the frequency domain. Thus, some versions of OOK may not meet a minimum bandwidth standard as specified by the regulator. Or, in some cases, the allowed transmit power may be very low, leading to poor range for the wireless system.

However, in some cases a wireless communication device may utilize a characteristic of a low power receiver such as an SRR in which the receiver detects the envelope of the RF signal and does not distinguish between two different RF signals with a different phase. For example, a low power receiver may detect the same value for the following two signals.

s₁=sin(2πf₀t) (1)

s₂=sin(2πf₀t+π)=−sin(2πf₀) (2)

In OOK, a logical one may have two amplitudes of a signal: A and 0, where A may be based on the average transmit power. If one factors out the A which only depends on the average transmit power one can say that there are two amplitudes: 1 and 0.

The transformation 710-a may map at least some of the logical ones to OOK symbols such as “−1” symbols so that there may be a phase difference of it (i.e. 180°). One can think of this as having two logical values: 1 and 0, while having three actual amplitudes on the RF signal: −1, 0 and 1. At the transmitter half of the logical 1′s may be mapped to actual amplitude of 1 and half of the logical 1′s are mapped to actual amplitude of −1.

Thus, at baseband one may have the below mapping, with half the logical 1′s mapped to amplitude 1 and half the logical 1′s mapped to amplitude −1 the average power at the baseband signal may be zero. At RF there may be three RF symbols.

A*sin(2πf₀t) (3)

A*sin(2πf₀t+π) (4)

0 (5)

Because the low power receiver may not distinguish phase, it may detect just two amplitude levels: A and 0, which correspond to the original logical 1 and 0. Thus, the transmitter may transmit using ternary OOK, and the receiver may demodulate the message using binary OOK. As a result, in the frequency domain of the RF signal there may no longer be a strong narrowband signal at the carrier frequency. This may result in a wider band signal that can meet a regulatory minimum bandwidth standard. This may allow the transmitter to transmit at a higher power level and hence provide longer range.

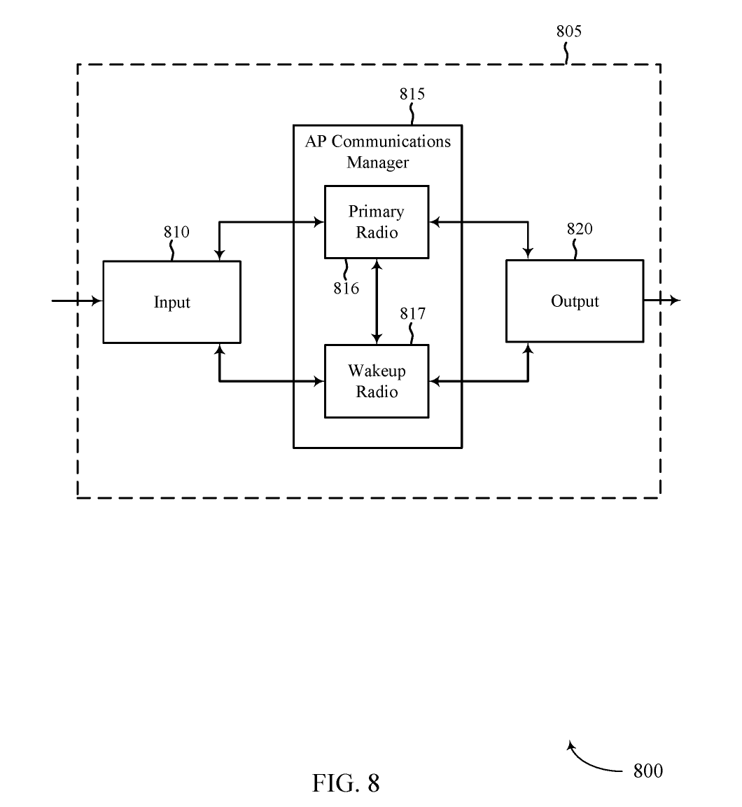

FIG. 8 shows a block diagram 800 of a wireless device 805 that supports physical layer design for wakeup radio in accordance with various aspects of the present disclosure. Wireless device 805 may be an example of aspects of an AP 105 as described with reference to FIG. 1. Wireless device 805 may include an input 810, access point communications manager 815, and an output 820. In some examples the input 810 may be a receiver and the output 820 may be a transmitter. Wireless device 805 may also include a processor. Each of these components may be in communication with one another (e.g., via one or more buses).

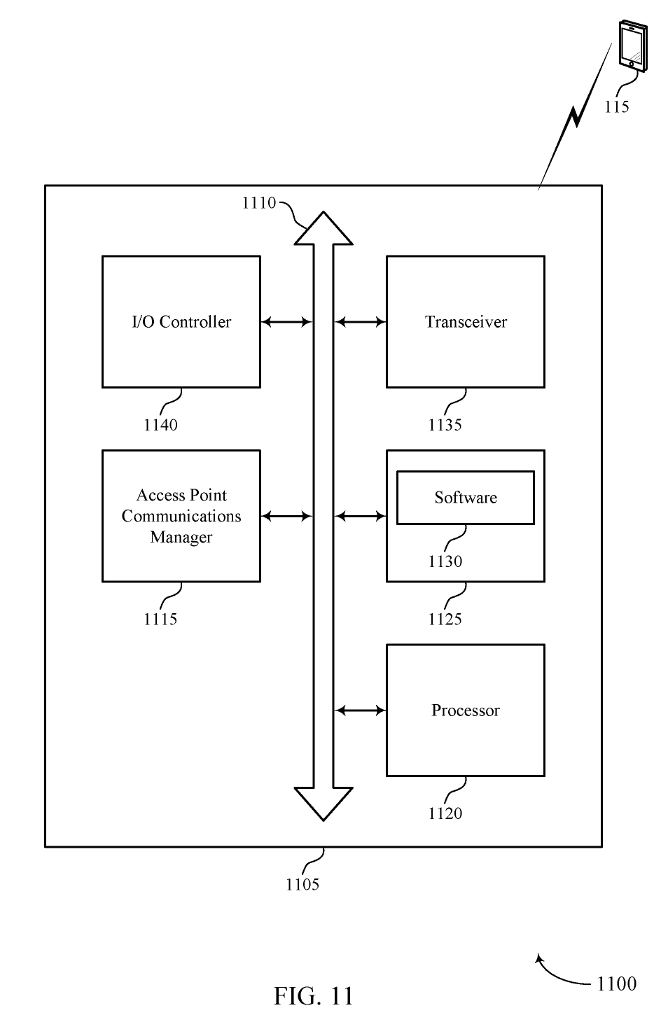

Input 810 may receive information such as packets, user data, or control information associated with various information channels (e.g., control channels, data channels, and information related to physical layer design for wakeup radio, etc.). Information may be passed on to other components of the device. The input 810 may be an example of aspects of the transceiver 1135 described with reference to FIG. 11.

Access point communications manager 815 may be an example of aspects of the access point communications manager 1115 described with reference to FIG. 11. The access point communications manager 815 may include a primary radio 816 and a wakeup radio 817 associated with the access point communications manager 815. The primary radio 816 may be an example of the primary radio 116 described with reference to FIGS. 1-2. The wakeup radio 817 may be an example of the wakeup radio 117 described with reference to FIGS. 1-2. In some examples, the primary radio 816 may be configured to establish a communication link that is able to handle a high-throughput of data. In some examples, the wakeup radio 817 may be configured to conserve power of the wireless device 805 and as such may have a lower data rate and lower throughput than the primary radio 816. In some instances, the wakeup radio 817 is a wakeup radio for use during a low-power mode. In some examples, the wakeup radio 817 may be configured to receive wakeup messages with different PHY packet structures. In some examples, the primary radio 816 exchanges data using a first radio access technology (RAT) such as LTE, 3G, or Wi-Fi and the wakeup radio 817 exchanges data using a second RAT different from the first RAT such as Bluetooth or Bluetooth Low Energy.

Access point communications manager 815 may identify a proximity of the wireless device to the access point, select a parameter value for a wakeup message for the wireless device from a set of parameter values based on the identified proximity, where a first value of the set of parameter values is associated with a first size for the wakeup message and a second value of the set of parameter values is associated with a second size for the wakeup message, transmit the wakeup message to a first radio of the wireless device, the wakeup message generated based on the selected parameter value, and exchange data with a second radio of the wireless device based on the transmitted wakeup message.

Output 820 may transmit signals generated by other components of the device. In some examples, the output 820 may be collocated with an input 810 in a transceiver module. For example, the output 820 may be an example of aspects of the transceiver 1135 described with reference to FIG. 11. The output 820 may include a single antenna, or it may include a set of antennas.

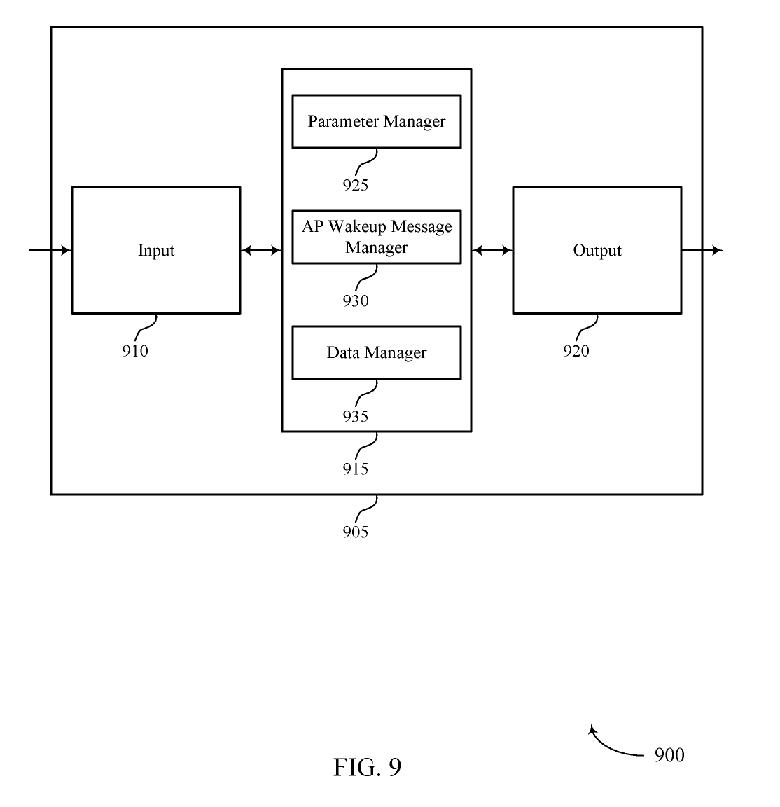

FIG. 9 shows a block diagram 900 of a wireless device 905 that supports physical layer design for wakeup radio in accordance with various aspects of the present disclosure. Wireless device 905 may be an example of aspects of a wireless device 805 or an AP 105 as described with reference to FIGS. 1 and 8. Wireless device 905 may include an input 910, access point communications manager 915, and an output 920. In some examples, the input 910 may be a receiver and the output 920 may be a transmitter. Wireless device 905 may also include a processor. Each of these components may be in communication with one another (e.g., via one or more buses).

Input 910 may receive information such as packets, user data, or control information associated with various information channels (e.g., control channels, data channels, and information related to physical layer design for wakeup radio, etc.). Information may be passed on to other components of the device. The input 910 may be an example of aspects of the transceiver 1135 described with reference to FIG. 11.

Access point communications manager 915 may be an example of aspects of the access point communications manager 1115 described with reference to FIG. 11.

Access point communications manager 915 may also include parameter manager 925, access point (AP) wakeup message manager 930, and data manager 935.

Parameter manager 925 may identify a proximity of the wireless device to the access point, select a parameter value for a wakeup message for the wireless device from a set of parameter values based on the identified proximity, where a first value of the set of parameter values is associated with a first size for the wakeup message and a second value of the set of parameter values is associated with a second size for the wakeup message, compare the identified path loss to a predetermined path loss threshold, and compare the identified receive power to a predetermined power threshold. In some cases, identifying the proximity of the wireless device to the access point includes determining a packet error rate associated with messages transmitted by the access point. In some cases, identifying the proximity of the wireless device to the access point includes identifying a path loss between the wireless device and the access point. In some cases, identifying the proximity of the wireless device to the access point includes identifying a receive power associated with a signal of the wireless device.

AP wakeup message manager 930 may transmit the wakeup message to a first radio of the wireless device, the wakeup message generated based on the selected parameter value. In some cases, transmitting the wakeup message generated based on the selected parameter value further includes modulating the wakeup message using a ternary OOK including bits represented with positive and negative amplitude. In some cases, transmitting the wakeup message further includes selecting a PN sequence associated with the first size or the second size for a preamble of the wakeup message based on the selected parameter value. In some cases, transmitting the wakeup message further includes modulating a second portion of the wakeup message to a sequence of symbols associated with the first size or the second size for the second portion of the wakeup message based on the selected parameter value. In some cases, a first portion of the wakeup message includes a preamble. In some cases, a second portion of the wakeup message includes a signal field and a data field. In some cases, the preamble includes a PN field. In some cases, the signal field indicates a data field size for the data field. In some cases, the second size is an integer multiple of the first size.

Data manager 935 may exchange data with a second radio of the wireless device based on the transmitted wakeup message.

Output 920 may transmit signals generated by other components of the device. In some examples, the output 920 may be collocated with an input 910 in a transceiver module. For example, the output 920 may be an example of aspects of the transceiver 1135 described with reference to FIG. 11. The output 920 may include a single antenna, or it may include a set of antennas.

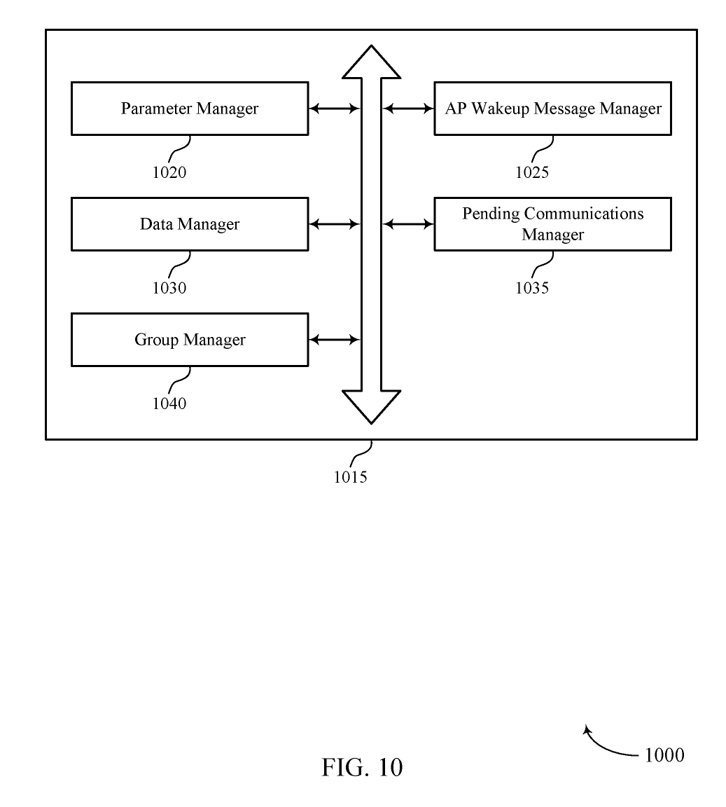

FIG. 10 shows a block diagram 1000 of an access point communications manager 1015 that supports physical layer design for wakeup radio in accordance with various aspects of the present disclosure. The access point communications manager 1015 may be an example of aspects of an access point communications manager 815, an access point communications manager 915, or an access point communications manager 1115 described with reference to FIGS. 8, 9, and 11. The access point communications manager 1015 may include parameter manager 1020, AP wakeup message manager 1025, data manager 1030, pending communications manager 1035, and group manager 1040. Each of these modules may communicate, directly or indirectly, with one another (e.g., via one or more buses).

Parameter manager 1020 may identify a proximity of the wireless device to the access point, select a parameter value for a wakeup message for the wireless device from a set of parameter values based on the identified proximity, where a first value of the set of parameter values is associated with a first size for the wakeup message and a second value of the set of parameter values is associated with a second size for the wakeup message, compare the identified path loss to a predetermined path loss threshold, and compare the identified receive power to a predetermined power threshold. In some cases, identifying the proximity of the wireless device to the access point includes determining a packet error rate associated with messages transmitted by the access point. In some cases, identifying the proximity of the wireless device to the access point includes identifying a path loss between the wireless device and the access point. In some cases, identifying the proximity of the wireless device to the access point includes identifying a receive power associated with a signal of the wireless device.

AP wakeup message manager 1025 may transmit the wakeup message to a first radio of the wireless device, the wakeup message generated based on the selected parameter value. In some cases, transmitting the wakeup message generated based on the selected parameter value further includes modulating the wakeup message using a ternary OOK including bits represented with positive and negative amplitude. In some cases, transmitting the wakeup message further includes selecting a PN sequence associated with the first size or the second size for a preamble of the wakeup message based on the selected parameter value. In some cases, transmitting the wakeup message further includes modulating a second portion of the wakeup message to a sequence of symbols associated with the first size or the second size for the second portion of the wakeup message based on the selected parameter value. In some cases, a first portion of the wakeup message includes a preamble. In some cases, a second portion of the wakeup message includes a signal field and a data field. In some cases, the preamble includes a PN field. In some cases, the signal field indicates a data field size for the data field. In some cases, the second size is an integer multiple of the first size.

Data manager 1030 may exchange data with a second radio of the wireless device based on the transmitted wakeup message.

Pending communications manager 1035 may receive an indication that the wireless device has entered a low-power mode, where identifying the proximity is based on the received indication. In some cases, the first radio includes a wakeup receiver. In some cases, the second radio includes a wireless local area network (WLAN) transceiver.

Group manager 1040 may assign the wireless device to a first of a set of groups of one or more wireless devices based on the identified proximity of the wireless device to the access point.

FIG. 11 shows a diagram of a system 1100 including a device 1105 that supports physical layer design for wakeup radio in accordance with various aspects of the present disclosure. Device 1105 may be an example of or include the components of wireless device 805, wireless device 905, or an AP 105 as described above, e.g., with reference to FIGS. 1, 8 and 9. Device 1105 may include components for bi-directional voice and data communications including components for transmitting and receiving communications, including access point communications manager 1115, processor 1120, memory 1125, software 1130, transceiver 1135, and I/O controller 1140. These components may be in electronic communication via one or more busses (e.g., bus 1110).

Processor 1120 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting physical layer design for wakeup radio).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support physical layer design for wakeup radio. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

I/O controller 1140 may manage input and output signals for device 1105. I/O controller 1140 may also manage peripherals not integrated into device 1105. In some cases, I/O controller 1140 may represent a physical connection or port to an external peripheral. In some cases, I/O controller 1140 may utilize an operating system such as iOS®, ANDROID®, MS-DOS®, MS-WINDOWS®, OS/2®, UNIX®, LINUX®, or another known operating system.

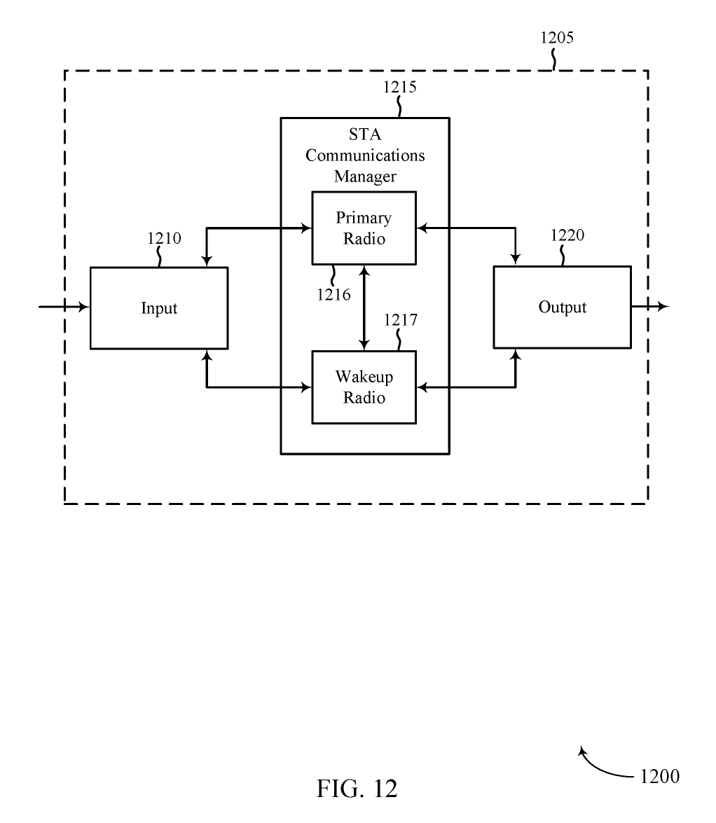

FIG. 12 shows a block diagram 1200 of a wireless device 1205 that supports physical layer design for wakeup radio in accordance with various aspects of the present disclosure. Wireless device 1205 may be an example of aspects of a wireless device 115 as described with reference to FIG. 1. Wireless device 1205 may include an input 1210, wireless device communications manager 1215, and an output 1220. In some examples, the input 1210 may be a receiver and the output 1220 may be a transmitter. Wireless device 1205 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

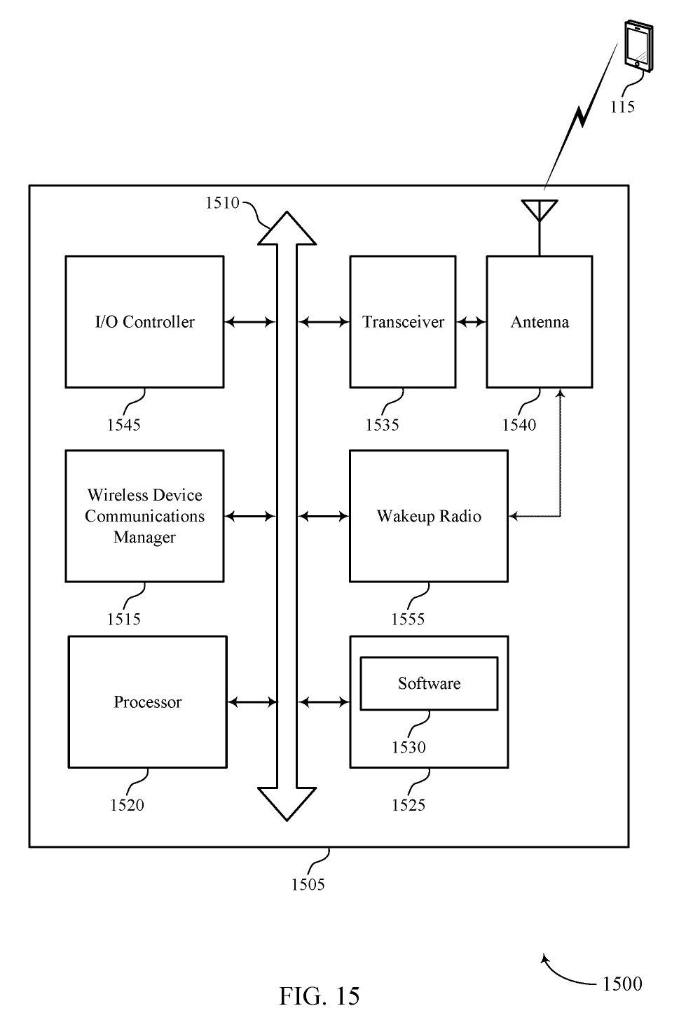

Input 1210 may receive information such as packets, user data, or control information associated with various information channels (e.g., control channels, data channels, and information related to physical layer design for wakeup radio, etc.). Information may be passed on to other components of the device. The input 1210 may be an example of aspects of the transceiver 1535 described with reference to FIG. 15.

Wireless device communications manager 1215 may be an example of aspects of the wireless device communications manager 1515 described with reference to FIG. 15. The STA communications manager 1215 may include a primary radio 1216 and a wakeup radio 1217 associated with the wireless device communications manager 1215. The primary radio 1216 may be an example of the primary radio 116 described with reference to FIGS. 1-2. The wakeup radio 1217 may be an example of the wakeup radio 117 described with reference to FIGS. 1-2. In some examples, the primary radio 1216 may be configured to establish a communication link that is able to handle a high-throughput of data. In some examples, the wakeup radio 1217 may be configured to conserve power of the wireless device 1205 and as such may have a lower data rate and lower throughput than the primary radio 1216. In some instances, the wakeup radio 1217 is a wakeup radio for use during a low-power mode. In some examples, the wakeup radio 1217 may be configured to receive wakeup messages with different PHY packet structures. In some examples, the primary radio 1216 exchanges data using a first radio access technology (RAT) such as LTE, 3G, or Wi-Fi and the wakeup radio 1217 exchanges data using a second RAT different from the first RAT such as Bluetooth or Bluetooth Low Energy.

Wireless device communications manager 1215 may receive a wakeup message at a first radio of the wireless device while the wireless device is in a low power mode, where the wakeup message is generated by the access point based on an identified proximity of the wireless device to the access point, decode the received wakeup message to obtain a device specific identifier e, and exchange data with the access point using a second radio of the wireless device based on the device specific identifier.

Output 1220 may transmit signals generated by other components of the device. In some examples, the output 1220 may be collocated with an input 1210 in a transceiver module. For example, the output 1220 may be an example of aspects of the transceiver 1535 described with reference to FIG. 15. The output 1220 may include a single antenna, or it may include a set of antennas.

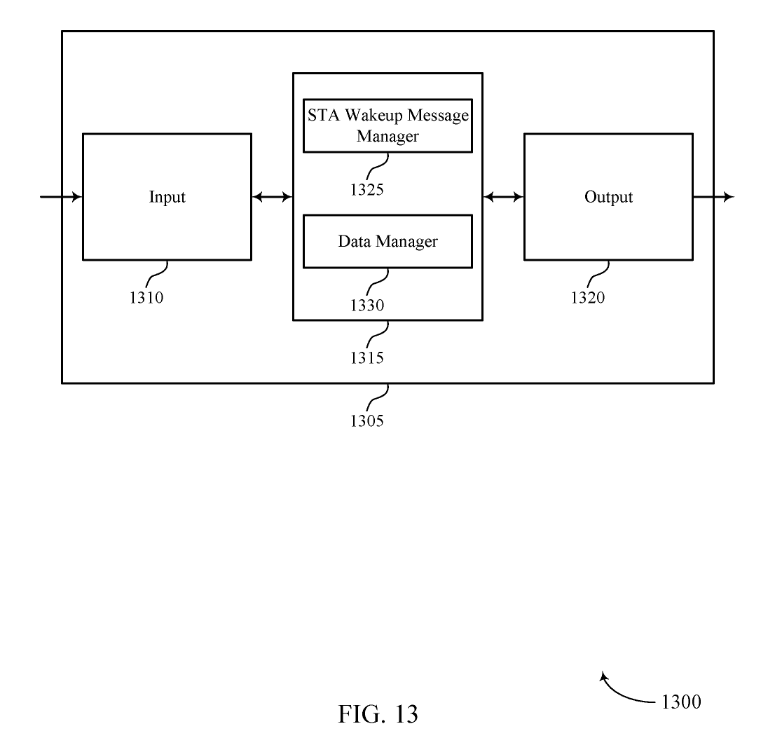

FIG. 13 shows a block diagram 1300 of a wireless device 1305 that supports physical layer design for wakeup radio in accordance with various aspects of the present disclosure. Wireless device 1305 may be an example of aspects of a wireless device 1205 or a wireless device 115 and 1205, as described with reference to FIGS. 1 and 12. Wireless device 1305 may include an input 1310, wireless device communications manager 1315, and an output 1320. In some examples, the input 1310 may be a receiver and the output 1320 may be a transmitter. Wireless device 1305 may also include a processor. Each of these components may be in communication with one another (e.g., via one or more buses).

Input 1310 may receive information such as packets, user data, or control information associated with various information channels (e.g., control channels, data channels, and information related to physical layer design for wakeup radio, etc.). Information may be passed on to other components of the device. The input 1310 may be an example of aspects of the transceiver 1535 described with reference to FIG. 15.

Wireless device communications manager 1315 may be an example of aspects of the wireless device communications manager 1515 described with reference to FIG. 15.

Wireless device communications manager 1315 may also include STA wakeup message manager 1325 and data manager 1330.

STA wakeup message manager 1325 may receive a wakeup message at a first radio of the wireless device while the wireless device is in a low power mode, where the wakeup message is generated by the access point based on an identified proximity of the wireless device to the access point, decode the received wakeup message to obtain a device specific identifier, and demodulate a portion of the received wakeup message using a ternary OOK including bits represented with positive and negative amplitude.

Data manager 1330 may exchange data with the access point using a second radio of the wireless device based on the device specific identifier.

Output 1320 may transmit signals generated by other components of the device. In some examples, the output 1320 may be collocated with an input 1310 in a transceiver module. For example, the output 1320 may be an example of aspects of the transceiver 1535 described with reference to FIG. 15. The output 1320 may include a single antenna, or it may include a set of antennas.

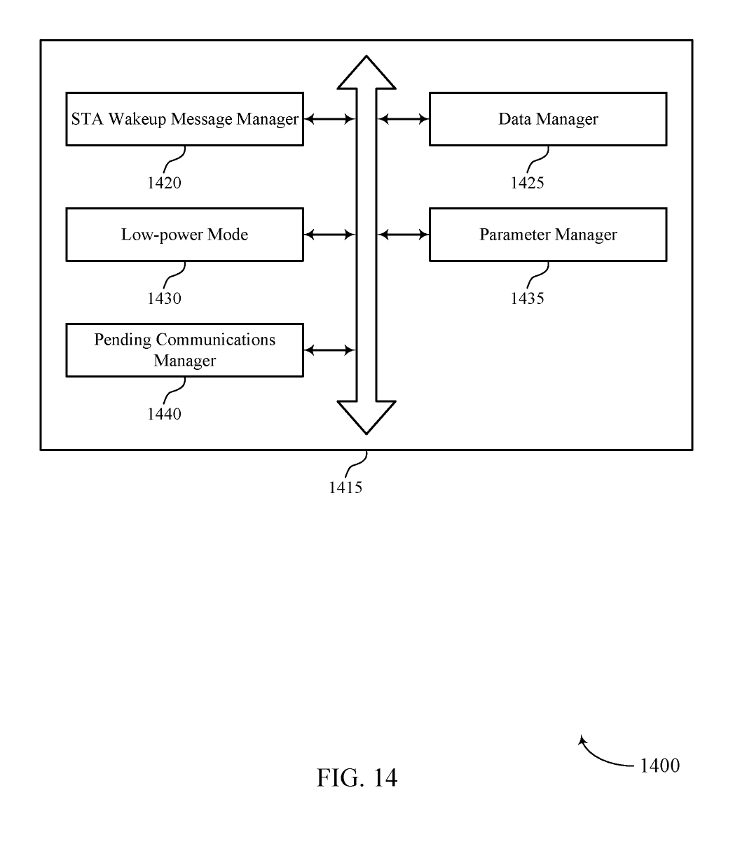

FIG. 14 shows a block diagram 1400 of a wireless device communications manager 1415 that supports physical layer design for wakeup radio in accordance with various aspects of the present disclosure. The wireless device communications manager 1415 may be an example of aspects of a wireless device communications manager 1515 described with reference to FIGS. 12, 13, and 15. The wireless device communications manager 1415 may include STA wakeup message manager 1420, data manager 1425, low-power mode 1430, parameter manager 1435, and pending communications manager 1440. Each of these modules may communicate, directly or indirectly, with one another (e.g., via one or more buses).

STA wakeup message manager 1420 may receive a wakeup message at a first radio of the wireless device while the wireless device is in a low power mode, where the wakeup message is generated by the access point based on an identified proximity of the wireless device to the access point, decode the received wakeup message to obtain a device specific identifier, and demodulate a portion of the received wakeup message using a ternary OOK including bits represented with positive and negative amplitude.

Data manager 1425 may exchange data with the access point using a second radio of the wireless device based on the device specific identifier.

Low-power mode 1430 may transmit, by the second radio, an indication that the wireless device is entering a low power mode and enter the low power mode.

Parameter manager 1435 may receive, from the access point, an indication of a parameter value used to generate the wakeup message based on the identified proximity.

Pending communications manager 1440 may manage systems associated with sending and receiving messages, such as radios. In some cases, the first radio includes a wakeup radio. In some cases, the second radio includes a WLAN transceiver.

FIG. 15 shows a diagram of a system 1500 including a device 1505 that supports physical layer design for wakeup radio in accordance with various aspects of the present disclosure. Device 1505 may be an example of or include the components of wireless device 115 as described above, e.g., with reference to FIG. 1. Device 1505 may include components for bi-directional voice and data communications including components for transmitting and receiving communications, including wireless device communications manager 1515, processor 1520, memory 1525, software 1530, primary radio 1550, wakeup radio 1555, antenna 1540, and I/O controller 1545. These components may be in electronic communication via one or more busses (e.g., bus 1510). Primary radio 1550 and wakeup radio 1555 may be examples of a primary radio 116, 816, and 1216 and wakeup radio 117, 817, and 1217 described with reference to FIGS. 1, 2, 8, and 12.

Processor 1520 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting physical layer design for wakeup radio).

Memory 1525 may include RAM and ROM. The memory 1525 may store computer-readable, computer-executable software 1530 including instructions that, when executed, cause the processor to perform various functions described herein. In some cases, the memory 1525 may contain, among other things, a BIOS which may control basic hardware and/or software operation such as the interaction with peripheral components or devices.

Software 1530 may include code to implement aspects of the present disclosure, including code to support physical layer design for wakeup radio. Software 1530 may be stored in a non-transitory computer-readable medium such as system memory or other memory. In some cases, the software 1530 may not be directly executable by the processor but may cause a computer (e.g., when compiled and executed) to perform functions described herein.

Primary radio 1550 may communicate bi-directionally, via one or more antennas, wired, or wireless links as described above. For example, primary radio 1550 may represent, or be a part of, a wireless transceiver and may communicate bi-directionally with another wireless transceiver. The primary radio 1550 may also include a modem to modulate the packets and provide the modulated packets to the antennas for transmission, and to demodulate packets received from the antennas.

In some cases, the wireless device may include a single antenna 1540. However, in some cases the device may have more than one antenna 1540, which may be capable of concurrently transmitting or receiving multiple wireless transmissions. I/O controller 1545 may manage input and output signals for device 1505. I/O controller 1545 may also manage peripherals not integrated into device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system.

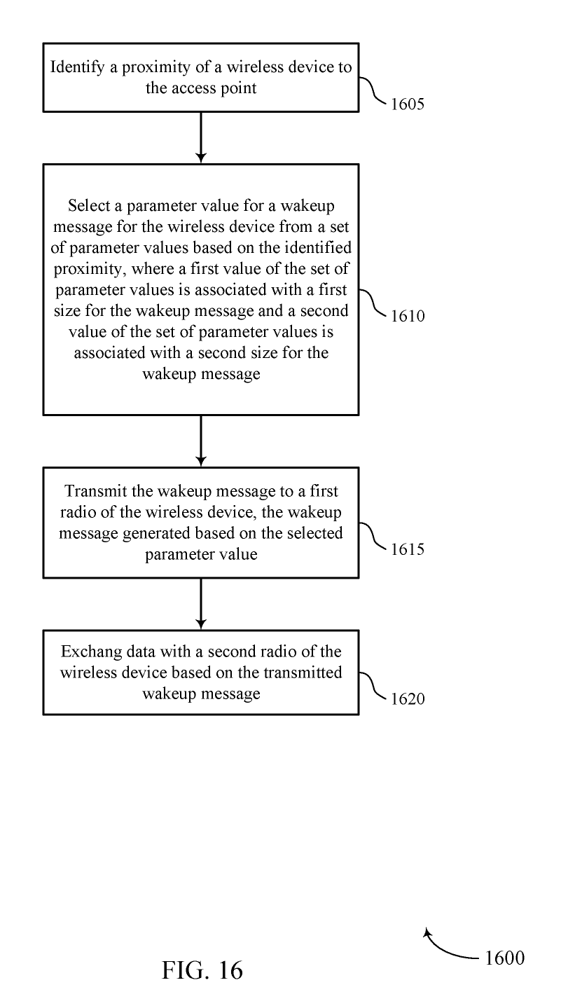

FIG. 16 shows a flowchart illustrating a method 1600 for physical layer design for wakeup radio in accordance with various aspects of the present disclosure. The operations of method 1600 may be implemented by an AP 105 or its components as described herein. For example, the operations of method 1600 may be performed by an access point communications manager as described with reference to FIGS. 8 through 11. In some examples, an AP 105 may execute a set of codes to control the functional elements of the device to perform the functions described below. Additionally or alternatively, the AP 105 may perform aspects the functions described below using special-purpose hardware.

At block 1605 the AP 105 may identify a proximity of the wireless device to the access point. The operations of block 1605 may be performed according to the methods described with reference to FIGS. 1 through 7. In certain examples, aspects of the operations of block 1605 may be performed by a parameter manager as described with reference to FIGS. 8 through 11.

At block 1610 the AP 105 may select a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message. The operations of block 1610 may be performed according to the methods described with reference to FIGS. 1 through 7. In certain examples, aspects of the operations of block 1610 may be performed by a parameter manager as described with reference to FIGS. 8 through 11.

At block 1615 the AP 105 may transmit the wakeup message to a first radio of the wireless device, the wakeup message generated based at least in part on the selected parameter value. The operations of block 1615 may be performed according to the methods described with reference to FIGS. 1 through 7. In certain examples, aspects of the operations of block 1615 may be performed by an AP wakeup message manager as described with reference to FIGS. 8 through 11.

At block 1620 the AP 105 may exchange data with a second radio of the wireless device based at least in part on the transmitted wakeup message. The operations of block 1620 may be performed according to the methods described with reference to FIGS. 1 through 7. In certain examples, aspects of the operations of block 1620 may be performed by a data manager as described with reference to FIGS. 8 through 11.

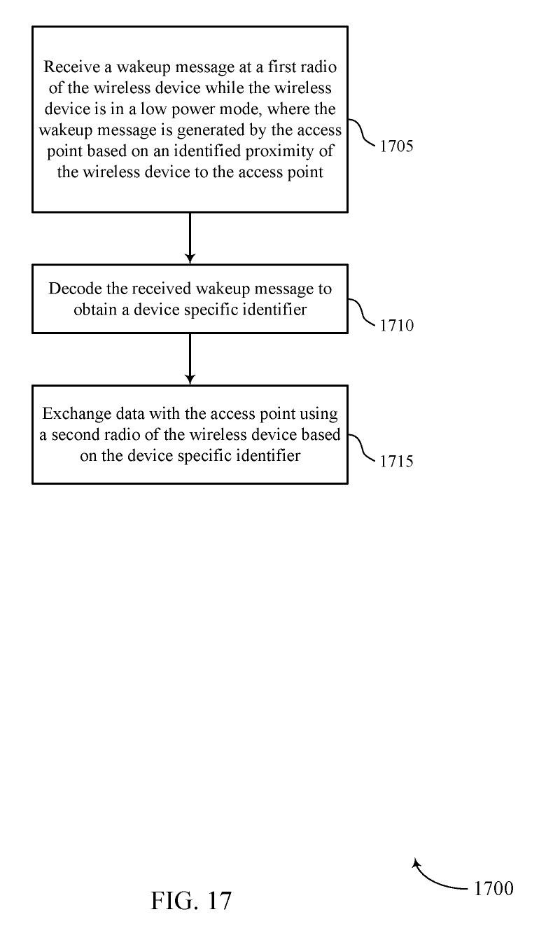

FIG. 17 shows a flowchart illustrating a method 1700 for physical layer design for wakeup radio in accordance with various aspects of the present disclosure. The operations of method 1700 may be implemented by a wireless device 115 or its components as described herein. For example, the operations of method 1700 may be performed by a wireless device communications manager as described with reference to FIGS. 12 through 15. In some examples, a wireless device 115 may execute a set of codes to control the functional elements of the device to perform the functions described below. Additionally or alternatively, the wireless device 115 may perform aspects the functions described below using special-purpose hardware.

At block 1705 the wireless device 115 may receive a wakeup message at a first radio of the wireless device while the wireless device is in a low power mode, wherein the wakeup message is generated by the access point based at least in part on an identified proximity of the wireless device to the access point. The operations of block 1705 may be performed according to the methods described with reference to FIGS. 1 through 7. In certain examples, aspects of the operations of block 1705 may be performed by a STA wakeup message manager as described with reference to FIGS. 12 through 15.

At block 1710 the wireless device 115 may decode the received wakeup message to obtain a device specific identifier. The operations of block 1710 may be performed according to the methods described with reference to FIGS. 1 through 7. In certain examples, aspects of the operations of block 1710 may be performed by a STA wakeup message manager as described with reference to FIGS. 12 through 15.

At block 1715 the wireless device 115 may exchange data with the access point using a second radio of the wireless device based at least in part on the device specific identifier. The operations of block 1715 may be performed according to the methods described with reference to FIGS. 1 through 7. In certain examples, aspects of the operations of block 1715 may be performed by a data manager as described with reference to FIGS. 12 through 15.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communication system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at an access point, comprising:
a processor;
memory in electronic communication with the processor; and
instructions stored in the memory and operable, when executed by the processor, to cause the apparatus to:
identify a proximity of a wireless device to the access point;
select a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message;
transmit the wakeup message to a first radio of the wireless device, the wakeup message generated based at least in part on the selected parameter value; and exchange data with a second radio of the wireless device based at least in part on the transmitted wakeup message.

2. The apparatus of claim 1, wherein the instructions are further executable by the processor to identify the proximity of the wireless device to the access point by being executable by the processor to:
determine a packet error rate associated with messages transmitted by the access point.

3. The apparatus of claim 2, wherein the instructions are further executable by the processor to identify the proximity of the wireless device to the access point by being executable by the processor to:
compare the determined packet error rate to a predetermined packet error rate threshold.

4. The apparatus of claim 1, wherein the instructions are further executable by the processor to identify the proximity of the wireless device to the access point by being executable by the processor to:
identify a path loss between the wireless device and the access point; and
compare the identified path loss to a predetermined path loss threshold.

5. The apparatus of claim 1, wherein the instructions are further executable by the processor to identify the proximity of the wireless device to the access point by being executable by the processor to:
identify a receive power associated with a signal of the wireless device; and
compare the identified receive power to a predetermined power threshold.

6. The apparatus of claim 1, wherein the instructions are further executable by the processor to:
receive an indication of the proximity of the wireless device to the access point identified based at least in part on the received indication.

7. The apparatus of claim 1, wherein the instructions are further executable by the processor to transmit the wakeup message by being executable by the processor to:
select a pseudo-random noise (PN) sequence associated with the first size or the second size for a preamble of the wakeup message based at least in part on the selected parameter value.

8. The apparatus of claim 1, wherein the instructions are further executable by the processor to transmit the wakeup message by being executable by the processor to:
modulate a second portion of the wakeup message to a set of symbols associated with the first size or the second size for the second portion of the wakeup message based at least in part on the selected parameter value.

9. The apparatus of claim 1, wherein:
a first portion of the wakeup message comprises a preamble; and
a second portion of the wakeup message comprises a signal field and a data field.

10. The apparatus of claim 9, wherein:
the preamble comprises a pseudo-random noise (PN) field.

11. The apparatus of claim 9, wherein:
the signal field indicates a data field size for the data field.

12. The apparatus of claim 1, wherein the instructions are further executable by the processor to:
receive an indication that the wireless device has entered a low-power mode.

13. The apparatus of claim 12, wherein the proximity is identified based at least in part on the received indication that the wireless device has entered the low-power mode.

14. The apparatus of claim 1, wherein the instructions are further executable by the processor to:
assign the wireless device to a first of a plurality of groups of one or more wireless devices based at least in part on the identified proximity of the wireless device to the access point.

15. The apparatus of claim 1, wherein the selected data parameter value comprises a data rate, or a modulation rate, or a coding rate, or a combination thereof.

16. The apparatus of claim 1, wherein the instructions are further executable by the processor to:
compare the identified proximity of the wireless device to a predetermined proximity threshold, wherein the parameter value is selected based at least in part on the comparison.

17. The apparatus of claim 1, wherein:
the second size is an integer multiple of the first size.

18. The apparatus of claim 1, wherein:
the first radio comprises a wakeup receiver; and
the second radio comprises a wireless local area network (WLAN) transceiver.

19. The apparatus of claim 1, wherein the apparatus is a wireless communication terminal and further comprises an antenna and transceiver.

20. A method for wireless communication at an access point, comprising:
identifying a proximity of a wireless device to the access point;
selecting a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message;
transmitting the wakeup message to a first radio of the wireless device, the wakeup message generated based at least in part on the selected parameter value; and exchanging data with a second radio of the wireless device based at least in part on the transmitted wakeup message.

21. The method of claim 20, wherein identifying the proximity of the wireless device to the access point comprises:
determining a packet error rate associated with messages transmitted by the access point; and
comparing the determined packet error rate to a predetermined packet error rate threshold.

22. The method of claim 20, wherein identifying the proximity of the wireless device to the access point comprises:
identifying a path loss between the wireless device and the access point; and
comparing the identified path loss to a predetermined path loss threshold.

23. The method of claim 20, wherein identifying the proximity of the wireless device to the access point comprises:
identifying a receive power associated with a signal of the wireless device; and
comparing the identified receive power to a predetermined power threshold.

24. The method of claim 20, wherein transmitting the wakeup message comprises:
selecting a pseudo-random noise (PN) sequence associated with the first size or the second size for a preamble of the wakeup message based at least in part on the selected parameter value.

25. The method of claim 20, wherein transmitting the wakeup message comprises:
modulating a second portion of the wakeup message to a set of symbols associated with the first size or the second size for the second portion of the wakeup message based at least in part on the selected parameter value.

26. The method of claim 20, wherein the selected data parameter value comprises a data rate, or a modulation rate, or a coding rate, or a combination thereof.

27. The method of claim 20, further comprising:
comparing the identified proximity of the wireless device to a predetermined proximity threshold, wherein the parameter value is selected based at least in part on the comparison.

28. An apparatus for wireless communication at an access point, comprising:
means for identifying a proximity of a wireless device to the access point;
means for selecting a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message;
means for transmitting the wakeup message to a first radio of the wireless device, the wakeup message generated based at least in part on the selected parameter value; and
means for exchanging data with a second radio of the wireless device based at least in part on the transmitted wakeup message.

29. The apparatus of claim 28, further comprising:
means for comparing the identified proximity of the wireless device to a predetermined proximity threshold, wherein the parameter value is selected based at least in part on the comparison.

30. A non-transitory computer readable medium storing code for wireless communication at an access point, the code comprising instructions executable by a processor to:
identify a proximity of a wireless device to the access point;
select a parameter value for a wakeup message for the wireless device from a set of parameter values based at least in part on the identified proximity, wherein a first value of the set of parameter values is associated with a first size for the wakeup message and a second value of the set of parameter values is associated with a second size for the wakeup message;
transmit the wakeup message to a first radio of the wireless device, the wakeup message generated based at least in part on the selected parameter value; and
exchange data with a second radio of the wireless device based at least in part on the transmitted wakeup message.
